(19) United States
(12) Patent Application Publication
(10) Pub. No.: US 2020/0027083 A1
(43) Pub. Date: Jan. 23, 2020

(54) ELECTRONIC SYSTEMS AND COMPUTERIZED METHODS FOR PREAUTHORIZING TRANSACTIONS AND PROCESSING PREAUTHORIZED TRANSACTIONS

(71) Applicant: Mastercard International Incorporated, Purchase, NY (US)

(72) Inventors: Gaurav K Patrni, Pune (IN); Ketan Shrikant Joshi, Pune (IN); Venkatesh Santosh Jagalpure, Pune (IN)

(21) Appl. No.: 16/502,990

(22) Filed: Jul. 3, 2019

(30) Foreign Application Priority Data
Jul. 19, 2018 (SG) 10201806189X

(51) Int. Cl. G06Q 20/40; G06Q 20/12

(52) U.S. Cl. CPC G06Q 20/40; G06Q 20/12

(57) ABSTRACT

The present disclosure generally relates to electronic systems and computerized methods for preauthorizing transactions and processing preauthorized transactions.

### CROSS-REFERENCE TO RELATED APPLICATION

This application is a U.S. National Stage filing under 35 U.S.C. § 119, based on and claiming benefits of and priority to Singapore Patent Application No. 10201806189X filed on Jul. 19, 2018. The entire disclosure of the above application is incorporated herein by reference for all purposes.

### TECHNICAL FIELD

The present disclosure generally relates to electronic systems and computerized methods for preauthorizing transactions and processing preauthorized transactions. Particularly, the present disclosure describes various embodiments of electronic systems and computerized methods for preauthorizing a transaction between a consumer and a merchant for purchasing merchandise from the merchant, as well as for processing such a preauthorized transaction.

### BACKGROUND

Transactions between merchants and consumers occur all the time and these transactions are performed online (e-commerce or internet retailing at merchant websites) or at transitional brick-and-mortar merchant retail stores. Consumers commonly purchase merchandise from merchants which are collected on the spot (transaction at merchant retail store) and delivered to the consumers' homes (online transaction at merchant website). In some cases, a consumer may want to purchase merchandise as gifts to another person. One way to do this is to purchase the merchandise online and have it delivered to the recipient's home. However, if the consumer does not know the recipient's address and prefers to keep the gifting as a surprise, the consumer may instead have the merchandise delivered to the consumer's home. The consumer would then need to handover the merchandise in person to the recipient, similar to the consumer purchasing the merchandise from a merchant retail store and later handing over them merchandise to the recipient. This can become quite time-consuming and cumbersome for both the consumer and recipient, especially if the merchandise is bulky, such as furniture. Although the consumer may purchase vouchers which can be electronically communicated to the recipient, gifting of vouchers may seem somewhat unthoughtful or insensitive and not suitable as gifts to persons who are closer to the consumer, such as spouses, close relatives or friends.

United States patent publication 20160224954 describes a method for conducting a preauthorized transaction identified by a preauthorization token. The preauthorization token is encoded with payment details and is provided to a merchant to process the preauthorized transaction. The preauthorization token can be used for various transactions, including recurring payment transactions, and could potentially be misused. United States patent publication 20140046846 describes a method of processing a reservation for a preauthorized transaction so that a third party receives merchandise from a merchant. A consumer device is required to make the reservation with a reservation server, and the method may not be suitable for consumers who prefer to transact with merchants at merchant retail stores.

Therefore, in order to address or alleviate at least one of the aforementioned problems and/or disadvantages, there is a need to provide improved electronic systems and computerized methods for preauthorizing transactions and processing preauthorized transactions.

### SUMMARY

According to a first aspect of the present disclosure, there is a payment network server, a computerized method, and a non-transitory computer-readable storage medium comprising instructions for preauthorizing a transaction between a consumer and a merchant for purchasing merchandise from the merchant. The payment network server comprises a preauthorization request module and a preauthorization response module configured for performing steps of the method.

The preauthorization request module is configured for: receiving, from the merchant, a request for preauthorization of the transaction, the preauthorization request comprising details of a payment instrument of the consumer, details of the merchant, and details of the transaction; and communicating, to an issuer server for the consumer payment instrument, the preauthorization request for preauthorizing payment of the transaction with the consumer payment instrument.

The preauthorization response module is configured for: receiving a preauthorization response from the issuer server, the preauthorization response comprising a preauthorization token generated by the issuer server based on the consumer payment instrument details, merchant details, and transaction details; and communicating the preauthorization token to the consumer, the preauthorization token useable at the merchant for validating the transaction.

Additionally, the transaction is held from further processing and the purchased merchandise is withheld until the transaction is validated with the preauthorization token; and the preauthorized payment is transferred from the consumer payment instrument to an account of the merchant and the purchased merchandise is released in response to said validation of the transaction.

According to a second aspect of the present disclosure, there is a payment network server, a computerized method, and a non-transitory computer-readable storage medium comprising instructions for preauthorizing a transaction between a consumer and a merchant for purchasing merchandise from the merchant. The method is performed by a server of the merchant and comprises: receiving, from the consumer, a request for preauthorization of the transaction, the preauthorization request comprising details of a payment instrument of the consumer; communicating the preauthorization request to a payment network server, the preauthorization request further comprising details of the merchant and details of the transaction; receiving, from the payment network server, a preauthorization token generated by an issuer server for the consumer payment instrument, based on the consumer payment instrument details, merchant details, and transaction details, for preauthorizing payment of the transaction with the consumer payment instrument; and communicating the preauthorization token to the consumer, the preauthorization token useable at the merchant for validating the transaction, wherein the transaction is held from further processing and the purchased merchandise is withheld until the transaction is validated with the preauthorization token; wherein the preauthorized payment is transferred from the consumer payment instrument to an account of the merchant and the purchased merchandise is released in response to said validation of the transaction using the preauthorization token.

According to a third aspect of the present disclosure, there is a payment network server, a computerized method, and a non-transitory computer-readable storage medium comprising instructions for processing a preauthorized transaction performed between a consumer and a merchant for purchasing merchandise from the merchant. The method is performed by a payment network server and comprises: receiving, from the merchant, a transaction request for processing the preauthorized transaction, the transaction request comprising a preauthorization token generated by an issuer server for a payment instrument of the consumer based on details of the consumer payment instrument, details of the merchant, and details of the preauthorized transaction; communicating the preauthorization token to the issuer server for validation of the preauthorized transaction, said validation comprising determining if payment of the preauthorized transaction with the consumer payment instrument has been preauthorized; receiving a validation response from the issuer server; and transferring the preauthorized payment from the consumer payment instrument to an account of the merchant in response to said validation of the preauthorized transaction, the purchased merchandise being withheld until the preauthorized transaction is validated; communicating a transaction request response to the merchant to release the purchased merchandise and thereby complete said processing of the preauthorized transaction

Electronic systems and computerized methods for preauthorizing a transaction and processing a preauthorized transaction, according to the present disclosure are thus disclosed herein. Various features, aspects, and advantages of the present disclosure will become more apparent from the following detailed description of the embodiments of the present disclosure, by way of non-limiting examples only, along with the accompanying drawings briefly described below.

### BRIEF DESCRIPTION OF THE DRAWINGS

FIG. 1 is an illustration of an electronic system for preauthorizing a transaction, in accordance with embodiments of the present disclosure.

FIG. 2 is a flowchart illustration of a computerized method implemented on a payment network server for preauthorizing a transaction, in accordance with embodiments of the present disclosure.

FIG. 3 is a flowchart illustration of a computerized method implemented on a merchant server for preauthorizing a transaction, in accordance with embodiments of the present disclosure.

FIG. 4 is a schematic illustration of a computerized method implemented on the electronic system for preauthorizing a transaction, in accordance with embodiments of the present disclosure.

FIG. 5 is a schematic illustration of a computerized method implemented on the electronic system for processing a preauthorized transaction, in accordance with embodiments of the present disclosure.

FIG. 6 is a block diagram illustration of the technical architecture of a server, in accordance with embodiments of the present disclosure.

### DETAILED DESCRIPTION

In the present disclosure, depiction of a given element or consideration or use of a particular element number in a particular figure or a reference thereto in corresponding descriptive material can encompass the same, an equivalent, or an analogous element or element number identified in another figure or descriptive material associated therewith. The use of “/” in a figure or associated text is understood to mean “and/or” unless otherwise indicated. For purposes of brevity and clarity, descriptions of embodiments of the present disclosure are directed to electronic systems and computerized methods for preauthorizing a transaction and processing a preauthorized transaction, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, known systems, methods, procedures, and components have not been described in detail so as to not unnecessarily obscure aspects of the embodiments of the present disclosure.

### Overview

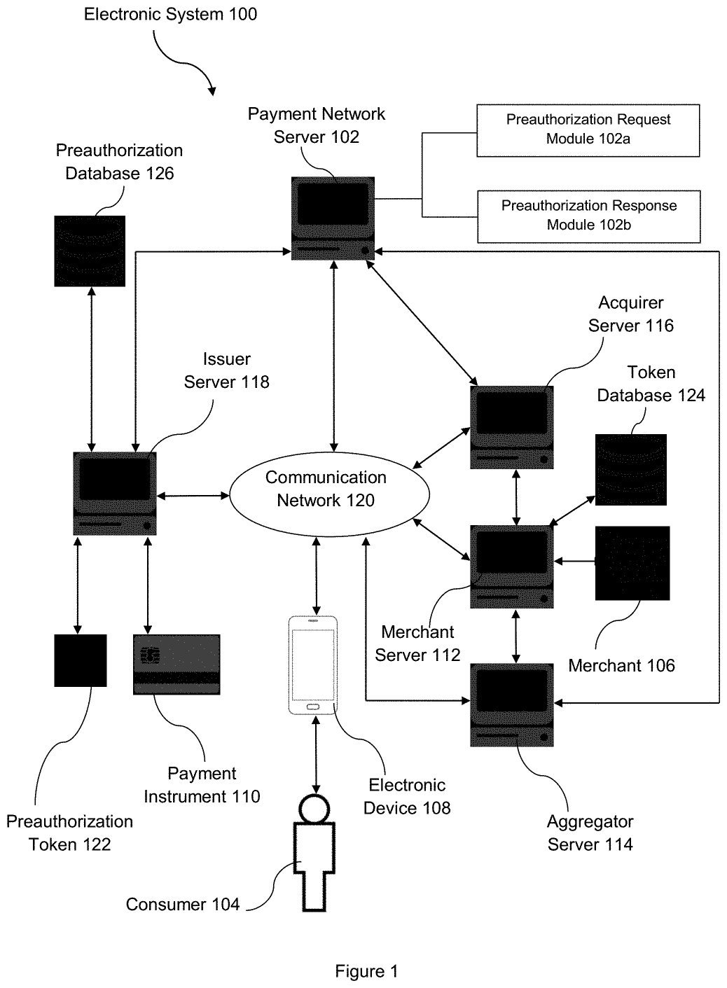

In representative or exemplary embodiments of the present disclosure, there is an electronic or computer system 100 including a payment network server 102 for preauthorizing a transaction between a consumer 104 and a merchant 106 for purchasing merchandise from the merchant 106, as illustrated in FIG. 1. The merchant 106 may be a business or commercial entity such as Amazon® or Walmart® that offers merchandise for purchase by the consumer 106. The merchant 106 may operate an online business establishment and/or a physical retail store. The system 100 includes an electronic device 108 which the consumer 104 can use to browse online catalogs of the merchant 106 and to purchase the merchandise from the merchant 106 using a payment instrument 110, such as a credit card. The system 100 further includes a server 112 of the merchant 106, an aggregator server 114 for the merchant 106, an acquirer server 116 for the merchant 106, and an issuer server 118 for the consumer payment instrument 110. The payment network server 102, consumer electronic device 108, merchant server 112, aggregator server 114, acquirer server 116, and issuer server 118 are communicable with one another through a communication network 120.

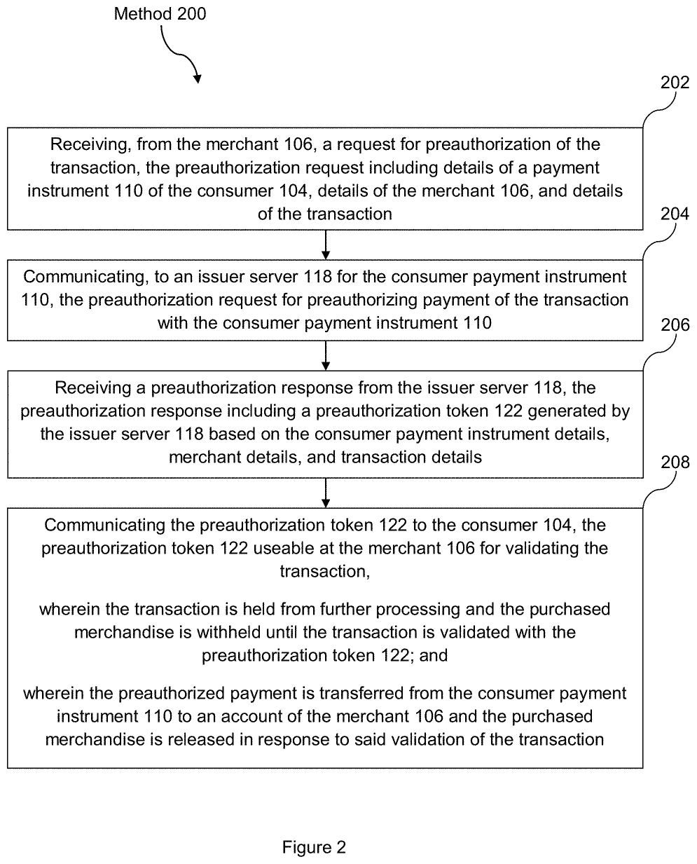

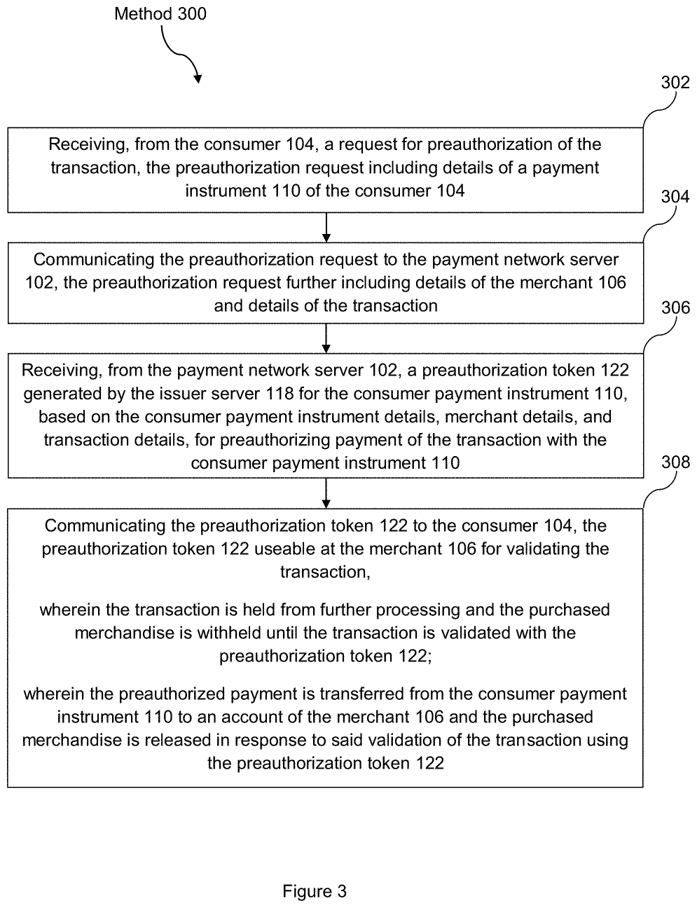

With reference to FIG. 2, there is shown a computer-implemented or computerized method 200 implemented on the payment network server 102 for preauthorizing a transaction between the consumer 104 and merchant 106 for purchasing merchandise from the merchant 106. The payment network server 102 includes various modules/components for performing various operations or steps of the method 200, including a preauthorization request module 102a and preauthorization response module 102b. Further with reference to FIG. 3, there is shown a corresponding computer-implemented or computerized method 300 implemented on the merchant server 112 for preauthorizing the transaction.

The consumer 104 intends to purchase merchandise from the merchant 106 for gifting to another person or recipient. The consumer 104 may shop for the merchandise online at the merchant's website or patronize the merchant's retail store, particularly if the consumer 104 prefers to see the actual merchandise. Various business establishments of the merchant 104, including the website and retail store, are communicable with the merchant server 112 for processing merchandise purchase transactions.

In a step 302 of the method 300, the merchant server 112 receives, from the consumer 104, a request for preauthorization of the transaction. The preauthorization request includes details of the consumer payment instrument 110, such as credit card number and expiry date. In a step 304, the merchant server 112 communicates the preauthorization request to the payment network server 102, which now further includes details of the merchant 106, such as merchant identification details, and details of the transaction, such as transaction amount and merchandise identification details. The tokenization request may be communicated from the merchant server 112 to the aggregator server 114 or acquirer server 116 and subsequently to the payment network server 102 through the communication network 120. Correspondingly, in a step 202 of the method 200, the preauthorization request module 102a of the payment network server 102 receives the preauthorization request from the merchant 108.

In a step 204, the preauthorization request module 102a of the payment network server 102 communicates, to the issuer server 118 for the consumer payment instrument 110, the preauthorization request for preauthorizing payment of the transaction with the consumer payment instrument 110. The preauthorization request is for the issuer server 118 to verify the details of the consumer payment instrument 110 so that payment of the transaction amount can be preauthorized and reserved from the consumer payment instrument 110.

In a step 206, the preauthorization response module 102b of the payment network server 102 receives a preauthorization response from the issuer server 118. The preauthorization response includes a preauthorization token 122 generated by the issuer server 118 based on the consumer payment instrument details, merchant details, and transaction details. The preauthorization token 122 indicates that the transaction has been preauthorized, i.e. payment of the transaction amount is authorized and reserved for this preauthorized transaction. In a step 208, the preauthorization response module 102b communicates the preauthorization token 122 to the consumer 104. The preauthorization response module 102b may communicate the preauthorization token 122 directly to the consumer 104. Alternatively, the preauthorization response module 102b communicates the preauthorization token 122 to the merchant 106 for storing on a token database 124 of the merchant 106, wherein the preauthorization token 122 is communicated from the merchant 106 to the consumer 104. Details of the preauthorized transaction and the preauthorization token 122 may also be stored on a preauthorization database 126 for the issuer server 118.

Correspondingly, in a step 306, the merchant server 112 receives the preauthorization token 122 from the payment network server 102. The merchant 106 may store the preauthorization token 122 on the merchant token database 124. In a step 308, the merchant 106 communicates the preauthorization token 122, which may be in the form of a numerical code, to the consumer 104. The consumer 104 may in turn give the preauthorization token 122 to another person or recipient.

The preauthorization token 122 is useable, whether by the consumer 104 or the recipient, at the merchant 106 for validating the transaction which has already been preauthorized. Furthermore, the preauthorized transaction is held from further processing and the purchased merchandise is withheld until the preauthorized transaction is validated with the preauthorization token 122. The consumer 104 or the recipient can provide or present the preauthorization token 122 to the merchant 106, such as physically at the merchant retail store or electronically via the merchant website. The merchant 106 communicates the presented preauthorization token 122 to the payment network server 102 which then transmits it to the issuer server 118 for validating the preauthorized transaction.

In response to validation of the preauthorized transaction the preauthorized payment of the transaction amount is transferred from the consumer payment instrument 110 to an account of the merchant 106. Additionally, after the preauthorized transaction is validated, the merchant 110 releases the purchased merchandise and thereby completes said processing of the preauthorized transaction.

Therefore, with the system 100, method 200, and method 300, the consumer 104 can preauthorize transactions with the merchant 106 for purchasing merchandise from the merchant 106, such as for gifting to a recipient. The preauthorization token 122 is generated by the issuer server 118 and received by the consumer 104 after the transaction is preauthorized. If the consumer 104 gives the preauthorization token 122 to the recipient and the recipient presents the preauthorization token 122 to the merchant 106, the recipient will be able to obtain the purchased merchandise directly from the merchant 106, since payment for the purchased merchandise has already been preauthorized.

### DESCRIPTION OF EMBODIMENTS

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment.

As used herein, the terms “component”, “module,” “system”, “apparatus”, “interface”, and the like are generally intended to refer to a computer-related entity, either hardware, a combination of hardware and software, software, or software in execution. For example, a component or a module may be, but is not limited to being, a process running on a processor, a processor, an object, an executable, a thread of execution, a program, and/or a computer. By way of illustration, both an application running on a controller and the controller can be a component/module. One or more components/modules may reside within a process and/or thread of execution. A component/module may be localized on one computer and/or distributed among a plurality of computers.

As used herein, the terms “a” and “an” are defined as one or more than one. The term “set” is defined as a non-empty finite organization of elements that mathematically exhibits a cardinality of at least one (e.g. a set as defined herein can correspond to a unit, singlet, or single-element set, or a multiple-element set), in accordance with known mathematical definitions. The recitation of a particular numerical value or value range herein is understood to include or be a recitation of an approximate numerical value or value range.

While various terms as used in representative or exemplary embodiments of the present disclosure are defined herein, the definitions of these terms are not intended to be limited as such and are in addition to their plain meanings according to standard English dictionaries.

In various embodiments of the present disclosure, the electronic system 100 includes the payment network server 102 for preauthorizing a transaction between the consumer 104 and the merchant 106 for purchasing merchandise from the merchant 106. The system 100 further includes the consumer electronic device 108, merchant server 112, aggregator server 114, acquirer server 116, and issuer server 118, wherein one or more or all of which are communicable with one another through the communication network 120.

The payment network server 102 is a computer server associated with a payment network of various payment instruments and which is operated by an intermediary entity. Typically, the intermediary entity is a card association, such as a credit card association, that facilitates communications between acquirer institutions and issuer institutions to authorize and fund transactions performed using the consumer payment instruments 110. The payment network settles the transactions between various acquirer institutions and issuer institutions, when consumer payment instruments 110 such as credit cards are used for payment of transactions between consumers 104 and merchants 106. Some examples of payment networks operated by intermediary entities include the Banknet payment network operated by Mastercard® and the VisaNet payment network operated by Visa®. Some other examples of intermediary entities that operate payment networks include American Express®, Discover®, and Diners Club®. In many embodiments, the payment network server 102 and the payment network associated therewith facilitate preauthorizing of transactions and processing of preauthorized transactions between the consumer 104 and the merchant 106. The payment network may be integrated with or complements the communication network 120 to facilitate said preauthorizing and said processing. The payment network server 102 generates credit and/or debit notifications based on payment processing of a transaction. The credit and/or debit notifications are communicated to the acquirer server 116 and issuer server 118 for crediting and/or debiting the respective financial accounts corresponding to the transaction. More specifically, upon processing of the transaction, the consumer payment instrument 110 is debited and the merchant financial account is credited, thereby transferring funds from the consumer payment instrument 110 to the merchant financial account.

The consumer 104 is an individual who is an account holder of an account which refers to any financial account, such as current account, savings account, trading account, or any account associated with the consumer payment instrument 110. In some embodiments, the account is a bank account maintained by a financial institution, such as an issuer institution or bank. In some other embodiments, the account is a digital wallet maintained by a merchant 106, the intermediary entity, an issuer institution or bank, or a third-party service provider. The account is linked to the consumer payment instrument 110 and thus the consumer payment instrument 110 stores identification information of the account. The account identification information may be stored in the form of an electronic chip or a machine-readable magnetic strip embedded in the consumer payment instrument 110. The account identification information may include an account number and the name of the account holder (i.e. consumer 104). The consumer payment instrument 110 has a unique identifier, an expiry date, security data, and type. The payment instrument identifier, expiry date, security data, and type constitute details of the consumer payment instrument 110.

The consumer payment instrument 110 refers to any suitable cashless payment mechanism, such as payment cards or transaction cards, which the consumer 104 may use to perform transactions, such as deposits and withdrawals, credit transfers, merchandise purchase, payment transactions, and the like. In some embodiments, the consumer payment instrument 110 is a physical card, such as credit card, debit card, membership card, promotional card, contactless card, charge card, frequent flyer card, gift card, prepaid card, or the like. The consumer payment instrument 110 may be radio frequency identification (RFID) or near field communication (NFC) enabled for performing contactless payment transactions. In some other embodiments, the consumer payment instrument 110 is stored electronically in memory of the consumer electronic device 108, such as on an application or digital wallet resident or operative on the consumer electronic device 108.

The consumer electronic device 108 is an electronic/communication device that enables the consumer 104 to purchase goods, products, and/or services through e-commerce sites (e.g. card-not-present payment transactions) or at a point-of-sale (POS) terminal (e.g. physical in-store payment transactions) associated with the merchant 106. The consumer electronic device 108 may be a mobile device, mobile phone, smartphone, personal digital assistant (PDA), key fob, transponder device, NFC-enabled device, tablet, phablet, laptop, computer, other communication device, or the like.

The merchant 106 is a business or commercial entity that offers various merchandise, including goods, products, and services, in exchange for payments. The merchant 106 may establish an account with a financial institution, such as an acquirer institution or bank to accept the payments from consumers 104 by use of the consumer payment instruments 110. Alternatively, the merchant 106 may establish an account with a payment aggregator which provides a service for merchants to process payment transactions. The merchant 106 operates the merchant server 112 that is a computer server associated with a merchant apparatus/billing machine or a POS terminal in a merchant's retail premises, or an e-commerce website on which transactions can be initiated by the consumers 104.

The aggregator server 114 is a computer server operated by a payment aggregator that aggregates various merchants 106 on a single platform. The payment aggregator serves as an interface between the merchant server 112 and payment network server 102, so that the merchant 106 does not need to setup an account with the acquirer institution. Some non-limiting examples of payment aggregators include PayPal®, Stripe®, Atos®, and CyberPlat®. In some embodiments, the payment network server 102 and aggregator server 114 are separate entities. The aggregator server 114 receives transaction information from the merchant server 112 and communicates the transaction information to the payment network server 102. In some other embodiments, the functionalities of the aggregator server 114 are integrated into the payment network server 102 such that they operate as an integrated or single entity.

The acquirer server 116 is a computer server operated by an acquirer institution or bank at which merchants 106 maintain merchant accounts to receive and accept payments for goods, products, and/or services purchased by the consumers 104. Account information of the merchant accounts established with the acquirer institution is stored as account profiles in an acquirer database of the acquirer institution. The acquirer database may reside locally on the acquirer server 116, or alternatively on a remote or cloud server communicatively linked to the acquirer server 116. The acquirer institution processes transactions requested from the merchant server 112 by using the acquirer server 116. The acquirer server 116 communicates transaction information to the payment network server 102 and/or issuer institutions through the communication network 120. The acquirer server 116 is configured for crediting the financial account of the merchant 106 maintained in the acquirer institution upon processing of the transactions.

The issuer server 118 is a computer server operated by an issuer institution or bank Issuer or issuer bank where accounts of consumers 104 are established and maintained. The issuer institution ensures payment for authorized transactions in accordance with various payment network regulations and local legislation. Account information of the accounts established with the issuer institution is stored as account profiles in an issuer database of the issuer institution. The issuer database may reside locally on the issuer server 118, or alternatively on a remote or cloud server communicatively linked to the issuer server 118. The account information may include an account balance, a credit line, details of an account holder, transaction history of the account holder, account identification information, and the like. The details of the account holder may include identification number, name, age, gender, date of birth, physical attributes, contact numbers, email addresses, and the like of the account holder. The issuer server 118 is configured for debiting the consumer payment instrument 110, or an account of the consumer 104 linked thereto that is maintained in the issuer institution, upon processing of the transaction.

As used herein, the term “institution” is not necessarily limited to organizations which are legally constituted as banks. In some jurisdictions or countries, other organizations may be permitted to maintain financial accounts such as a payment card account. An institution may thus be one of the following: a bank, financial technology company, and financial institution. It will be appreciated that the acquirer server 116 and issuer server 118 receive various credit and debit notifications/messages from the payment network server 102. Based on the credit and debit notifications, the acquirer server 116 credits the merchant account and issuer server 118 debits the consumer account or consumer payment instrument 110 linked thereto. It will be further appreciated that said crediting and debiting via the acquirer server 116 and issuer server 118 respectively will be readily apparent to the skilled person and may include processing via the conventional four-party system or three-party system.

The communication network 120 is a medium or environment through which content, notifications, and/or messages are communicated among various entities, including the payment network server 102, consumer electronic device 108, merchant server 112, aggregator server 114, acquirer server 116, and issuer server 118. Some non-limiting examples of the communication network 120 include a virtual private network (VPN), wireless fidelity (Wi-Fi) network, light fidelity (Li-Fi) network, local area network (LAN), wide area network (WAN), metropolitan area network (MAN), satellite network, Internet, fiber optic network, coaxial cable network, infrared (IR) network, radio frequency (RF) network, and any combination thereof. Various entities in the communication network 120 may connect to the communication network 120 in accordance with various wired and wireless communication protocols, such as Transmission Control Protocol/Internet Protocol (TCP/IP), User Datagram Protocol (UDP), 2nd to 5th Generation (2G to 5G) communication protocols, Long Term Evolution (LTE) communication protocols, and any combination thereof. Each of the payment network server 102, consumer electronic device 108, merchant server 112, aggregator server 114, acquirer server 116, and issuer server 118 includes a data communication or transceiver module to communicate and transmit/receive data over the communication network 120. Some non-limiting examples of a transceiver module include an antenna module, a radio frequency transceiver module, a wireless transceiver module, a Bluetooth transceiver module, an Ethernet port, a Universal Serial Bus (USB) port, or any other module/component/device configured for transmitting and receiving data.

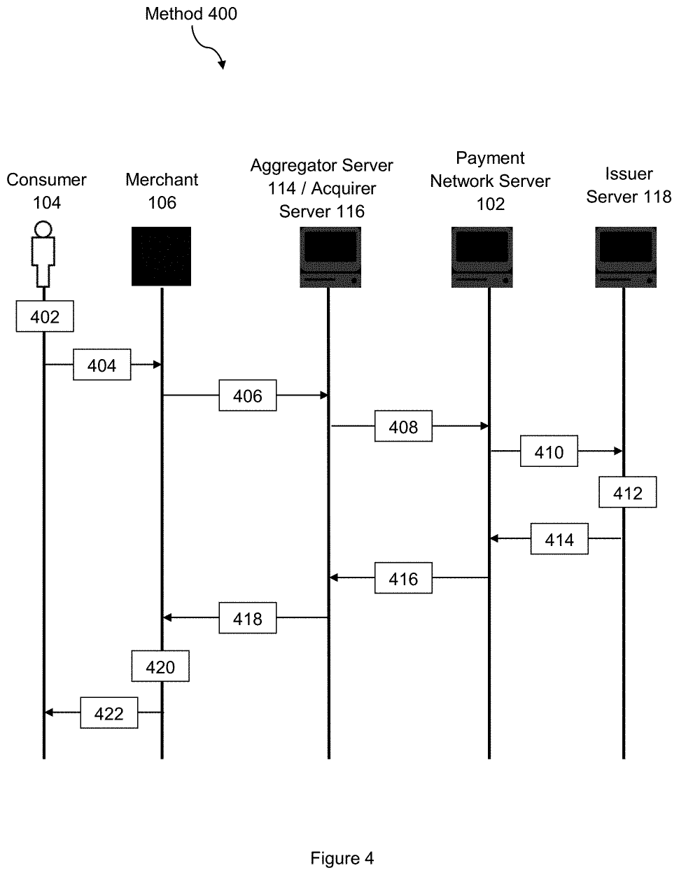

In various embodiments with reference to FIG. 4, there is a computer-implemented or computerized method 400 implemented on the system 100 for preauthorizing a transaction between a consumer 104 and a merchant 106 for purchasing merchandise from the merchant 106. The consumer 104 intends to purchase merchandise from the merchant 106 for gifting to another person or recipient. In one embodiment, the consumer 104 patronizes a physical retail store of the merchant 106 and shops for the merchandise, particularly if the consumer 104 prefers to see the actual merchandise. The merchant retail store has a merchant apparatus/billing machine or POS terminal installed and communicable with the merchant server 112. The consumer 106 presents the consumer payment instrument 110 at the POS terminal and proceeds with the transaction for payment of the merchandise. In another embodiment, the consumer 104 shops for the merchandise online at an e-commerce website of the merchant 106 accessible on the consumer electronic device 108. The consumer 104 selects the merchandise and proceeds to the checkout page where the consumer 104 provides details of the consumer payment instrument 110. The consumer payment instrument details are communicable to the merchant server 112 to perform the transaction for payment of the merchandise.

In a step 402 of the method 400, the consumer 104 initiates, at the merchant retail store or website, a request for preauthorization of the transaction. The consumer 104 provides details of the consumer payment instrument 110 in the preauthorization request. In a step 404, the merchant server 112 receives the preauthorization request including the consumer payment instrument details from the consumer 104. The consumer payment instrument 110 may be a credit card and the details thereof include the credit card number and expiry date. The consumer payment instrument details may further include authentication details such as a security code or PIN. In a step 406, the merchant server 112 communicates the preauthorization request to the aggregator server 114/acquirer server 116 through the communication network 120. It will be appreciated that the merchant server 112 is communicable with the aggregator server 114 or acquirer server 116 depending on whether the merchant 106 has an account with a payment aggregator or acquirer financial institution. The preauthorization request communicated from the merchant server 112 further includes details of the merchant 106, such as merchant identification details, and details of the transaction, such as transaction amount and merchandise identification details. It will be appreciated that the consumer payment instrument details, merchant details, and transaction details are in accordance with one or more standards for the interchange of transaction messages, such as the ISO 8583 standard.

In a step 408, the preauthorization request module 102a of the payment network server 102 receives the preauthorization request from the merchant server 112 via the aggregator server 114/acquirer server 116. In a step 410, the preauthorization module 102a of the payment network server 102 communicates, to the issuer server 118 for the consumer payment instrument 110, the preauthorization request for preauthorizing payment of the transaction with the consumer payment instrument 110. The preauthorization request includes the consumer payment instrument details, merchant details, and transaction details, and is in accordance with one or more standards for the interchange of transaction messages, such as the ISO 8583 standard.

In a step 412, the issuer server 118 processes the preauthorization request. Particularly, the issuer server 118 verifies the details of the consumer payment instrument 110 against the issuer database. Optionally, the issuer server 120 communicates an authentication request to the consumer 106 requesting the consumer 104 to provide other authentication details, such as a one-time password (OTP). For example, the issuer server 118 may communicate a text message to the consumer electronic device 108 containing the OTP which the consumer 104 is required to input via the merchant website. Conventionally, in order to authorize payment of the transaction amount with the consumer payment instrument 110, the issuer server 118 is configured for verifying one or more of the credit card number, expiry date, and authentication details of the consumer payment instrument 110. Particularly, the issuer server 118 checks an available balance or funds of the account of the consumer 104 linked to the consumer payment instrument 110 to determine if the available balance is sufficient for the transaction amount. The available balance may include any overdraft balance available to the consumer account. The issuer server 118 then authorizes the transaction amount if the consumer payment instrument details are verified and that the available balance is equal to or more than the transaction amount. Upon authorization, the aggregate value is reserved and blocked out from the available balance. Thus, preauthorization of payment of the transaction by the issuer server 118 means that the transaction amount has been preauthorized and reserved from the consumer payment instrument 110. Details of the preauthorized transaction and the preauthorization token 122 are stored on the preauthorization database 126 of the issuer institution. The issuer preauthorization database 126 may reside locally on the issuer server 118, or alternatively on a remote or cloud server communicatively linked to the issuer server 118.

In a step 414, the preauthorization response module 102b of the payment network server 102 receives a preauthorization response from the issuer server 118. The preauthorization response indicates if the consumer payment instrument 110 is authorized or declined, and is in accordance with one or more standards for the interchange of payment transaction messages, such as the ISO 8583 standard. Furthermore, the preauthorization response includes a preauthorization token 122 generated by the issuer server 118 based on the consumer payment instrument details, merchant details, and transaction details. The preauthorization token 122 indicates that the transaction has been preauthorized, i.e. payment of the transaction amount is authorized and reserved for this preauthorized transaction. As will be readily understood by the skilled person, the preauthorization token 122 contains secure surrogate data that replaces sensitive data such as the consumer payment instrument details.

In a step 416, the preauthorization response module 102b of the payment network server 102 communicates, to the aggregator server 114/acquirer server 116, the preauthorization token 122 for subsequent communication to the merchant 106 and consumer 104. Alternatively, the preauthorization response module 102b of the payment network server 102 communicates the preauthorization token 122 directly to the consumer 104. In a step 418, the merchant server 112 receives the preauthorization token 122 from the aggregator server 114/acquirer server 116. In a step 420, the merchant 106 stores the preauthorization token 122 on the merchant token database 124. The merchant token database 124 stores preauthorization tokens 122 from multiple preauthorized transactions for subsequent verification of preauthorization tokens 122 presented to the merchant 106. The merchant token database 124 may reside locally on the merchant server 112, or alternatively on a remote or cloud server communicatively linked to the merchant server 112.

In a step 422, the merchant 106 communicates the preauthorization token 122 to the consumer 104. In one embodiment, the merchant server 112 communicates the preauthorization token 122 to the consumer electronic device 108 such that the preauthorization token 122 is displayable on the consumer electronic device 108. The consumer 104 may save the preauthorization token 122 on the consumer electronic device 108 and later communicate it to the recipient. In another embodiment, the merchant server 112 communicates the preauthorization token 122 to the POS terminal at the merchant retail store, and the POS terminal displays the preauthorization token 122 to the consumer 104. The consumer 104 may note down the preauthorization token 122 for gifting to the recipient. In yet another embodiment, the preauthorization token 122 is displayed on the merchant website which the consumer 104 has used to initiate the preauthorization request.

In some embodiments, the preauthorization token 122 is in the form of optical codifed data, such as barcode, Quick Response (QR) code, EZcode, high capacity color barcode, ShotCode, MaxiCode, GTIN12 code, GTIN-13 code, and Aztec code. For example, the preauthorization token 122 is the form of a QR code which the consumer 104 may communicate as an image to the recipient using the consumer electronic device 108.

In some embodiments, the preauthorization token 122 is in the form of a numerical code or sequence of digits. The consumer 104 may note down the sequence of digits on the consumer electronic device 108 or on paper, which the consumer 104 later gives to the recipient. In one embodiment, the preauthorization token 122 is in the form of a sequence of digits. The sequence of digits includes a first set of digits, such as the first 6 digits. The first set of digits is based on the consumer payment instrument details and represents an issuer identifier for identifying an issuer institution operating the issuer server 118, i.e. the issuer institution that issued the consumer payment instrument 110. The issuer identifier may also be referred to as bank identification number (BIN) or issuer identification number (IIN). The sequence of digits includes a second set of digits, such as the 7th and 8th digits. The second set of digits is a classification identifier that classifies the preauthorization token 122 as being associated with a preauthorized transaction. The sequence of digits includes a third set of digits, which is a transaction identifier that associates the preauthorization token 122 with a specific preauthorized transaction. Thus, the transaction identifier uniquely associates the preauthorization token 122 with the transaction which has been preauthorized and for which the issuer server 118 has generated the preauthorization token 122.

The preauthorization token 122 is useable, whether by the consumer 104 or the recipient, at the merchant 106 for validating the transaction which has already been preauthorized. Furthermore, the preauthorized transaction is held from further processing and the purchased merchandise is withheld until the preauthorized transaction is validated with the preauthorization token 122. Particularly, the preauthorized transaction cannot be settled and cleared as per the standard processing of a typical transaction, and the purchased merchandise are placed on hold at the merchant 106, until the preauthorized transaction is validated using the preauthorization token 122. The consumer 104 or the recipient can provide or present the preauthorization token 122 to the merchant 106, such as physically at the merchant retail store or electronically via the merchant website. Upon presentment of the preauthorization token 122, the merchant server 112 communicates the preauthorization token 122 to the payment network server 102 which then transmits it to the issuer server 118 for validating the preauthorized transaction.

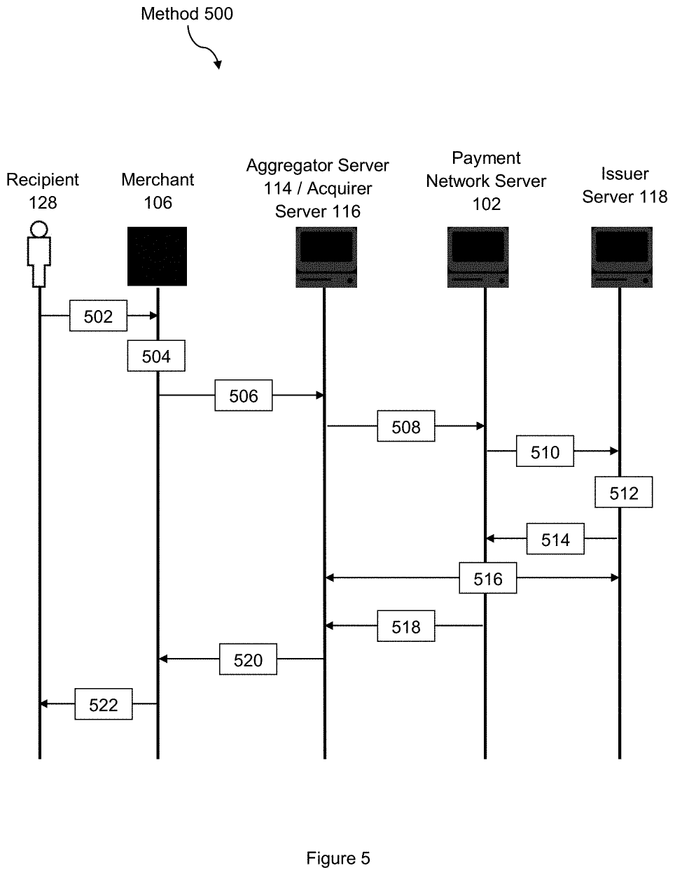

Therefore, with the method 400 implemented on the system 100, a transaction between the consumer 104 and the merchant 106 can be preauthorized for purchasing merchandise from the merchant 106 by the consumer 104 for gifting the merchandise to a recipient 128. In various embodiments with reference to FIG. 5, there is a computer-implemented or computerized method 500 implemented on the system 100 for processing the preauthorized transaction.

In a step 502 of the method 500, the recipient 128 provides or presents the preauthorization token 122 to the merchant 106. In one embodiment, the preauthorization token 122 is a numerical code and the recipient 128 enters the numbers at the merchant website. In another embodiment, the recipient 128 enters the numbers at the POS terminal at the merchant retail store. In yet another embodiment, the preauthorization token 122 is a QR code and the POS terminal scans the QR code to receive the preauthorization token 122.

In a step 504, the merchant server 112 generates a transaction request for processing the preauthorized transaction. The transaction request includes the preauthorization token 122 which was generated by the issuer server 118 based the consumer payment instrument details, merchant details, and preauthorized transaction details. In some embodiments, before the step 504, the merchant server 112 verifies the preauthorization token 122 against the merchant token database 124. Particularly, the merchant server 112 verifies whether the preauthorization token 122 presented by the recipient 128 is identical to one of the preauthorization tokens 122 stored on the merchant token database 124. The merchant server 112 generates the transaction request in response to verification of the preauthorization token 122. In a step 506, the merchant server 112 communicates the transaction request to the aggregator server 114/acquirer server 116 through the communication network 120. It will be appreciated that the merchant server 112 is communicable with the aggregator server 114 or acquirer server 116 depending on whether the merchant 106 has an account with a payment aggregator or acquirer financial institution.

In a step 508, a transaction module of the payment network server 102 receives the transaction request from the merchant server 112 via the aggregator server 114/acquirer server 116. In a step 510, a validation module of the payment network server 102 communicates the preauthorization token 122 to the issuer server 118 for validation of the preauthorized transaction. In a step 512, the issuer server 118 performs said validation of the preauthorized transaction. Particularly, said validation includes determining if payment of the preauthorized transaction with the consumer payment instrument 110 has been preauthorized. Details of preauthorized transactions and the preauthorization tokens 122 associated therewith generated by the issuer server 118 are stored on the issuer preauthorization database 126. Said validation is thus performed by the issuer server 118 against the issuer preauthorization database 126. Particularly, the issuer server 118 verifies whether the preauthorization token 122 is identical to one of the preauthorization tokens 122 stored on the issuer preauthorization database 126 and whether the preauthorization token 122 matches a preauthorized transaction.

In some embodiments, the issuer preauthorization database 126 is separate from a transaction database of the issuer institution. The transaction database stores details of standard or non-preauthorized transactions which are processed by the issuer server 118. Separating databases for preauthorized transactions and standard/non-preauthorized transactions improves efficiency in validation of the preauthorized transactions with the preauthorization tokens 122, as the issuer preauthorization database 126 does not contain unnecessary information from the standard/non-preauthorized transactions which creates noise in the validation process.

It should be noted that preauthorization of the transaction performed by the issuer server 118 is different from an authorization hold in standard transaction processing. In authorization holds, funds are held by the issuer institution and deducted from a consumer's credit limit but are not yet transferred to the merchant.

The merchant is required to submit the finalized transactions to the acquirer institution to begin the settlement process and clear the transactions. The funds are transferred to the merchant account after settlement. However, from the consumer's perspective, the transaction has been completed after the authorization hold and the consumer would be able to collect the purchased merchandise from the merchant. In contrast, preauthorization of transactions according to embodiments of the present disclosure involve reserving funds from an account linked to the consumer payment instrument 110. Details of preauthorized transactions are stored the issuer preauthorization database 126 which is separate from the transaction database. A preauthorized transaction cannot be settled or cleared by the merchant 106 until the preauthorized transaction is validated with the preauthorization token 122. From the perspective of the consumer 104, at the time of preauthorizing the transaction, the transaction is not yet complete and the consumer 104 would not be able to collect the purchased merchandise. The purchased merchandise can be collected or delivered after presentment of the preauthorization token 122 to the merchant 106.

After the preauthorized transaction is validated, details of the preauthorized transaction on the issuer preauthorization database 126 may be updated accordingly such that it cannot be validated again. Additionally, the preauthorization token 122 stored on the issuer preauthorization database 126 may be nullified after said validation. This mitigates the risk of duplicate transaction requests using the same preauthorization token 122. As the preauthorization token 122 can only be used once, there is little likelihood of the preauthorization token 122 being misused.

In some embodiments, the preauthorization token 122 is associated or encoded with the date and time of generating the preauthorization token 122 by the issuer server 118. Additionally, the preauthorization token 122 has an expiration period or expiration date determined by the issuer server 118. For example, preauthorization token 122 may be associated or encoded with a specific expiration date or an expiration period such as 1 week from its generation date. Said validation of the preauthorized transaction by the issuer server 118 in the step 512 may include determining if the expiration period or expiration date has passed. If the transaction request for processing the preauthorized transaction is initiated after the expiration period or expiration date has passed, the preauthorization token 122 is longer be valid and the preauthorized transaction cannot be validated.

In some embodiments, the preauthorization token 122 is nullified and the transaction is invalidated after the expiration period or expiration date. Nullification of the preauthorization token 122 renders it null and void for any further use, i.e. the nullified preauthorization token 122 cannot be used to validate the preauthorized transaction. Details of the preauthorized transaction are also updated to invalidate it, thereby preventing it from being validated. Thus, if the preauthorization token 122 is not presented to the merchant 106 before the expiration period or expiration date has passed, the preauthorized transaction will be invalidated and the preauthorization token 122 nullified. The payment amount which was already preauthorized will be released by the issuer server 118 and returned to the consumer payment instrument 110.

In a step 514, the validation module of the payment network server 102 receives a validation response from the issuer server 118. The validation response indicates whether the preauthorized transaction has been successfully validated or not. In a step 516, the transaction module of the payment network server 102 transfers the preauthorized payment from the consumer payment instrument 110 to the merchant account in response to said validation of the transaction. It will be appreciated that the payment transfer involves the aggregator server 114/acquirer server 116 and issuer server 118 and is performed in a standard manner readily known to the skilled person. In a step 518, the transaction module of the payment network server 102 communicates a transaction request response to the aggregator server 114/acquirer server 116. In a step 520, the merchant server 112 receives the transaction request response from the aggregator server 114/acquirer server 116. The transaction request response informs the merchant 106 that the preauthorized transaction has been validated and that the purchased merchandise can be released. In a step 522, the merchant 106 releases the merchandise, which were initially purchased by the consumer 104 using the consumer payment instrument 110, to the recipient 128, thereby completing said processing of the preauthorized transaction.

According to the methods 400 and 500, the consumer 104 can preauthorize transactions with the merchant 106 for purchasing merchandise from the merchant 106, such as for gifting to a recipient 128. The consumer 104 is not limited in the mode of transaction with the merchant 106 when preauthorizing the transaction. Particularly, the consumer 104 may purchase the merchandise an online website of the merchant 106, or from a physical retail store the merchant 106 if the consumer 104 prefers to shop for and see the actual merchandise.

The preauthorization token 122 is generated by the issuer server 118 and received by the consumer 104 after the transaction is preauthorized. If the consumer 104 gives the preauthorization token 122 to the recipient 128 and the recipient 128 presents the preauthorization token 122 to the merchant 106, the recipient 128 will be able to obtain the purchased merchandise directly from the merchant 106, since payment for the purchased merchandise has already been preauthorized. This saves time for both the consumer 104 and recipient 128, as the recipient 128 can arrange with the merchant 106 to have the merchandise delivered to the recipient's address. The preauthorization token 122 also does not contain sensitive information of the consumer 104, such as credit card details, and can be safely given to the recipient 128 without risking the credit card details being compromised.

In some cases, the consumer 104 may request preauthorization of multiple transactions. Validation of each preauthorized transaction at the merchant 106 using the respective preauthorization tokens 122 can be performed faster as there is no need to repeat the usual authorization steps, such as providing security codes, PINs, and/or OTPs. The consumer 104 or recipient 128 only needs to provide or present the preauthorization tokens 122 which can be in numerical codes, to the merchant 106 in order to validate the preauthorized transactions.

### Technical Architecture

As used herein, a server is a physical or cloud data processing system on which a server program runs. The server may be implemented in hardware or software, or a combination thereof. Some non-limiting examples of the payment network server 102, merchant server 112, aggregator server 114, acquirer server 116, and issuer server 118 include computers, laptops, mini-computers, mainframe computers, any non-transient and tangible machines that can execute a machine-readable code, cloud-based servers, distributed server networks, and a network of computer systems.

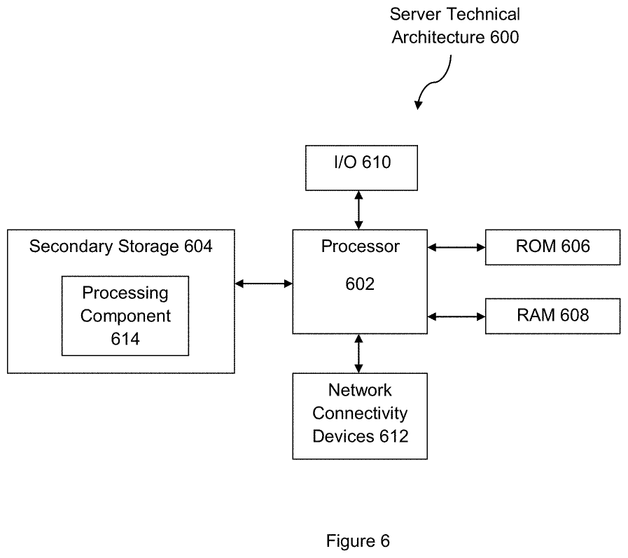

FIG. 6 is a block diagram illustrating a technical architecture 600 of the payment network server 102. The merchant server 112, aggregator server 114, acquirer server 116, and issuer server 118 may share a similar technical architecture.

The technical architecture 600 includes a processor 602 (also referred to as a central processor unit or CPU) that is in communication with memory devices including secondary storage 604 (such as disk drives or memory cards), read-only memory (ROM) 606, and random-access memory (RAM) 608. The processor 602 may be implemented as one or more CPU chips. Various modules or components for performing various operations or steps of the methods 200/300/400/500 are configured as part of the processor 602 and such operations or steps are performed in response to non-transitory instructions operative or executed by the processor 602. The processor 602 includes suitable logic, circuitry, and/or interfaces to execute such operations or steps. Some non-limiting examples of the processor 602 include an application-specific integrated circuit (ASIC) processor, a reduced instruction set computing (RISC) processor, a complex instruction set computing (CISC) processor, a field-programmable gate array (FPGA), and the like.

The technical architecture 600 further includes input/output (I/O) devices 610, and system connectivity/network devices 612. The secondary storage 604 typically includes one or more memory cards, disk drives, tape drives, or other storage devices and is used for non-volatile storage of data and as an over-flow data storage device if RAM 608 is not large enough to hold all working data. Secondary storage 604 may be used to store programs which are loaded into RAM 608 when such programs are selected for execution.

The secondary storage 604 has a processing component 614 including non-transitory instructions operative by the processor 602 to perform various operations or steps of the methods 200/300/400/500 according to various embodiments of the present disclosure. The ROM 606 is used to store instructions and perhaps data which are read during program execution. The secondary storage 604, the ROM 606, and/or the RAM 608 may be referred to in some contexts as computer-readable storage media and/or non-transitory computer-readable media. Non-transitory computer-readable media include all computer-readable media, with the sole exception being a transitory propagating signal per se.

The I/O devices 610 may include printers, video monitors, liquid crystal displays (LCDs), plasma displays, touch screen displays, keyboards, keypads, switches, dials, mice, track balls, voice recognizers, card readers, paper tape readers, and/or other known input devices.

The system connectivity/network devices 612 may take the form of modems, modem banks, Ethernet cards, universal serial bus (USB) interface cards, serial interfaces, token ring cards, fibre distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communication (NFC), radio frequency identity (RFID), and/or other air interface protocol radio transceiver cards, and other known system connectivity/network devices. These system connectivity/network devices 612 may enable the processor 602 to communicate with the Internet or one or more intranets. With such a system/network connection, it is contemplated that the processor 602 might receive information from the network, or might output information to the network in the course of performing the operations or steps of the methods 200/300/400/500. Such information, which is often represented as a sequence of instructions to be executed using processor 602, may be received from and outputted to the network, for example, in the form of a computer data signal embodied in a carrier wave.

The processor 602 executes instructions, codes, computer programs, scripts which it accesses from hard disk, floppy disk, optical disk (these various disk-based systems may all be considered secondary storage 604), flash drive, ROM 606, RAM 608, or the system connectivity/network devices 612. While only one processor 602 is shown, multiple processors may be present. Thus, while instructions may be discussed as executed by a processor, the instructions may be executed simultaneously, serially, or otherwise executed by one or multiple processors.

The technical architecture 600 may be formed by one computer, or multiple computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the multiple computers. In an embodiment, virtualization software may be employed by the technical architecture 600 to provide the functionality of a number of servers that is not directly bound to the number of computers in the technical architecture 600. In an embodiment, the functionality disclosed above may be provided by executing the application and/or applications in a cloud computing environment. Cloud computing may include providing computing services via a system/network connection using dynamically scalable computing resources. A cloud computing environment may be established by an enterprise and/or may be hired on an as-needed basis from a third-party provider.

It is understood that by programming and/or loading executable instructions onto the technical architecture 600, at least one of the CPU 602, ROM 606, and RAM 608 are changed, transforming the technical architecture 600 in part into a specific purpose machine or apparatus having the functionality as taught by various embodiments of the present disclosure. It is fundamental to the electrical engineering and software engineering arts that functionality that can be implemented by loading executable software into a computer can be converted to a hardware implementation by known design rules.

Furthermore, various embodiments of the present disclosure may be implemented as a method, apparatus, or article of manufacture using standard programming and/or engineering techniques to produce software, firmware, hardware, or any combination thereof to control a computer to implement the disclosed embodiments. For instance, various embodiments may be implemented as a computer-readable medium embedded with a computer-executable program, which encompasses a computer program accessible from any computer-readable storage device or storage media. For example, computer-readable media can include but are not limited to magnetic storage devices (e.g. hard disk, floppy disk, or magnetic strips), optical discs (e.g. compact disc (CD), digital versatile disc (DVD), or Blu-ray disc), smart cards, flash memory devices (e.g. card, stick, or key drive), and solid state drives/memory devices.

In the foregoing detailed description, embodiments of the present disclosure in relation to electronic systems and computerized methods for preauthorizing a transaction and processing a preauthorized transaction are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A payment network server for preauthorizing a transaction between a consumer and a merchant for purchasing merchandise from the merchant, the payment network server comprising:
a preauthorization request module configured for:
receiving, from the merchant, a request for preauthorization of the transaction, the preauthorization request comprising details of a payment instrument of the consumer, details of the merchant, and details of the transaction; and
communicating, to an issuer server for the consumer payment instrument, the preauthorization request for preauthorizing payment of the transaction with the consumer payment instrument; and
a preauthorization response module configured for:
receiving a preauthorization response from the issuer server, the preauthorization response comprising a preauthorization token generated by the issuer server based on the consumer payment instrument details, merchant details, and transaction details; and
communicating the preauthorization token to the consumer, the preauthorization token useable at the merchant for validating the transaction,
wherein the transaction is held from further processing and the purchased merchandise is withheld until the transaction is validated with the preauthorization token; and
wherein the preauthorized payment is transferred from the consumer payment instrument to an account of the merchant and the purchased merchandise is released in response to said validation of the transaction.

2. The payment network server according to claim 1, wherein the preauthorization token has an expiration period or expiration date determined by the issuer server.

3. The payment network server according to claim 2, wherein the preauthorization token is nullified and the transaction is invalidated after the expiration period or expiration date.

4. The payment network server according to claim 1, wherein the preauthorization token comprises an issuer identifier based on the consumer payment instrument details for identifying an issuer institution operating the issuer server.

5. The payment network server according to claim 1, wherein the preauthorization token comprises a transaction identifier for associating the preauthorization token with the transaction.

6. The payment network server according to claim 1, the preauthorization response module further configured for communicating the preauthorization token to the merchant for storing on a token database of the merchant, wherein the preauthorization token is communicated from the merchant to the consumer.

7. A computerized method for preauthorizing a transaction between a consumer and a merchant for purchasing merchandise from the merchant, the method performed by a server of the merchant and comprising:
receiving, from the consumer, a request for preauthorization of the transaction, the preauthorization request comprising details of a payment instrument of the consumer;
communicating the preauthorization request to a payment network server, the preauthorization request further comprising details of the merchant and details of the transaction;
receiving, from the payment network server, a preauthorization token generated by an issuer server for the consumer payment instrument, based on the consumer payment instrument details, merchant details, and transaction details, for preauthorizing payment of the transaction with the consumer payment instrument; and
communicating the preauthorization token to the consumer, the preauthorization token useable at the merchant for validating the transaction,
wherein the transaction is held from further processing and the purchased merchandise is withheld until the transaction is validated with the preauthorization token;
wherein the preauthorized payment is transferred from the consumer payment instrument to an account of the merchant and the purchased merchandise is released in response to said validation of the transaction using the preauthorization token.

8. The method according to claim 7, wherein the preauthorization request is received from an electronic device of the consumer.

9. The method according to claim 7, wherein the preauthorization token is verified by the merchant against the merchant token database before validating the transaction.

10. The method according to claim 7, wherein the preauthorization token has an expiration period or expiration date determined by the issuer server.

11. The method according to claim 10, wherein the preauthorization token is nullified and the transaction is invalidated after the expiration period or expiration date.

12. The method according to claim 7, wherein the preauthorization token comprises a transaction identifier for associating the preauthorization token with the transaction.

13. The method according to claim 7, further comprising storing the preauthorization token on a token database of the merchant.

14. A computerized method for processing a preauthorized transaction performed between a consumer and a merchant for purchasing merchandise from the merchant, the method performed by a payment network server and comprising:
receiving, from the merchant, a transaction request for processing the preauthorized transaction, the transaction request comprising a preauthorization token generated by an issuer server for a payment instrument of the consumer based on details of the consumer payment instrument, details of the merchant, and details of the preauthorized transaction;
communicating the preauthorization token to the issuer server for validation of the preauthorized transaction, said validation comprising determining if payment of the preauthorized transaction with the consumer payment instrument has been preauthorized;
receiving a validation response from the issuer server; and
transferring the preauthorized payment from the consumer payment instrument to an account of the merchant in response to said validation of the preauthorized transaction, the purchased merchandise being withheld until the preauthorized transaction is validated;
communicating a transaction request response to the merchant to release the purchased merchandise and thereby complete said processing of the preauthorized transaction.

15. The method according to claim 14, wherein said validation is performed by the issuer server against a preauthorization database storing details of preauthorized transactions and preauthorization tokens associated therewith generated by the issuer server.

16. The method according to claim 15, wherein the issuer preauthorization database is separate from a transaction database storing details of non-preauthorized transactions processed by the issuer server.

17. The method according to claim 14, wherein the preauthorization token has an expiration period or expiration date determined by the issuer server.

18. The method according to claim 17, said validation further comprising determining if the expiration period or expiration date has passed.

19. The method according to claim 14, wherein the preauthorization token comprises a transaction identifier for associating the preauthorization token with the preauthorized transaction.

20. The method according to claim 14, wherein the preauthorization token comprises an issuer identifier associated with the issuer server.
